(19) United States
(12) Patent Application Publication
(10) Pub. No.: US 2010/0260273 A1
(43) Pub. Date: Oct. 14, 2010

(54) Method and apparatus for smooth convergence during audio discontinuous transmission

(75) Inventors: Mark Raifel, Ra'anana (IL); Yaakov Chen, Rishon Le'zion (IL); Eli Fogel, Herzeliya (IL)

Correspondence Address: LERNER, DAVID, LITTENBERG,;KRUMHOLZ & MENTLIK, 600 SOUTH AVENUE WEST, WESTFIELD, NJ, 07090, US

(73) Assignee: DSP Group Limited, Herzelia (IL)

(21) Appl. No.: 12/386,057

(22) Filed: Apr. 13, 2009

(51) Int. Cl. H04B 14/04; G10L 15/00

(52) U.S. Cl. 375/254; 704/231; 704/E15.001

(57) ABSTRACT

A method of maintaining signal convergence of a transmitter and a receiver of an adaptive differential pulse code modulated (ADPCM) communication system during discontinuous transmission, by generating synchronized comfort noise frame in the transmitter and in the receiver during quiet periods and mutually updating the receiver's decoder and encoder on their states.

### FIELD OF THE INVENTION

The field of the invention relates to communication systems and in particular to audio communication systems.

### BACKGROUND OF THE INVENTION

Adaptive differential pulse code modulation (ADPCM) encoders and decoders are widely used in voice transmission systems. ADPCM voice transmission systems rely on the characteristic of voice signal to slowly vary over time. Thus, there is no need to transmit the encoded voice signal but only a difference signal is transmitted. Both the encoder at the transmitting end and the decoder at the receiving end use a coded ADPCM signal for feedback to perform both prediction and parameter adaptation. While both ends use the same encoded ADPCM signal for prediction and adaptation there is no need to transmit any additional information beyond the difference signal. The use of the same ADPCM signal for parameter adaptation and prediction also guarantees the convergence of the transmitter and receiver to the same state, enabling a continuous synchronization between the transmitter and the receiver.

The convergence of transmitter's encoder and the receiver's decoder depends on continuous transmission throughout an entire communication session. Interruption in the communication session results with losing synchronization and convergence between the transmitter and the receiver. The convergence of the transmitter and the receiver depends on both transmitter's encoder and receiver's decoder processing the same information. While voice information is characterized by relatively long quiet periods (gap in the audio) which are typically at the order of 50% of the total period, it is desired that the encoder should stop its transmission during these quiet periods. Thus, in the case that a transmitter identifies a silent period (gap in the audio signal) and stops transmission while keeping the encoder's activity, the decoder's activity is suspended during these quite periods, resulting with inconsistency between the information that is processed by the encoder and the decoder. This inconsistency results with artifact in the audio output when the audio signal resumes because at this point in time the parameters that are stored in the encoder and in the decoder are not synchronized.

One solution suggests to maintain transmission during quiet periods. However this solution is inefficient due to power consumption, redundant radiation (electromagnetic pollution), reduced bandwidth and other reasons. There is a need for solution that saves power and avoids redundant radiation and still keeps the convergence of the ADPCM system intact.

U.S. Pat. No. 5,559,832 by Laird (hereinafter “Laird”) discloses two solutions to the problem of holding transmission in the periods of silence. The first solution according to Laird suggests to interrupt the clocks of both the transmitter and receiver upon detection of silence by a VAD (Voice Activity Detector), and outputting noise frames by the receiver from a predefined pool of noise frames. The second solution according to Laird suggests to feed both the transmitter and receiver engines with null frames upon detection of a silent period, and outputting noise frames by the receiver from a predefined pool of noise frames.

The second solution has a drawback that will be noticed at the time of resuming audio transmission, since null frames actually result with clearing the parameters both in the transmitter's encoder and in the transceiver's decoder. The moment when audio transmission is restored will be accompanied with artifacts of the audio, since the state of both encoder and decoder does not correspond to the noise that is provided by the receiver's decoder and this point of discontinuity will be noticed by a listener. The first solution according to Laird is expected to result with better transitions between signal transmission and quiet periods, however, since the transmitter does not process the noise frames that are being outputted by the receiver, the transition between a quiet period and resumed signal transmission is not expected to be smooth.

There is a need for a solution that enables smooth transition between signal transmission and quiet period and vice versa.

### SUMMARY OF THE INVENTION

An aspect of an embodiment of the invention, relates to a system and method of maintaining signal convergence of a transmitter and a receiver of an adaptive differential pulse code modulated (ADPCM) communication system during discontinuous transmission. In an exemplary embodiment of the subject matter there is provided a transmitter including an encoder and a comfort noise generator (CNG) and a receiver including an encoder, a decoder and a CNG, wherein during signal presence the signal is encoded by the transmitter's encoder and transmitted to the receiver, where the signal is decoded by the receiver's decoder; when the transmitter detects a quiet period (gap in audio signal, discontinuity of the signal) the transmitter's CNG generates comfort noise frames that are encoded by the transmitter's encoder, these comfort noise frames are not transmitted to the receiver. When the receiver detects a quiet period, the receiver's CNG generates comfort noise frames that are synchronized to the transmitter's comfort noise frames, these comfort noise frames are encoded by the receiver's encoder. The receiver's encoder and decoder update each other on their states, i.e. when a quiet period starts the receiver's encoder is updated with the receiver's decoder state and when a quiet period ends, the receiver's decoder is updated with the receiver's encoder state.

In an exemplary embodiment in accordance with the disclosed subject matter, there is provided a method of maintaining signal convergence of a transmitter and a receiver of an adaptive differential pulse code modulated (ADPCM) communication system during discontinuous transmission, said method comprising the steps of: detecting, at a transmitter quiet periods in a signal to be transmitted; encoding comfort noise frames in an encoder of the transmitter during said quiet periods in the signal to be transmitted, wherein said encoded comfort noise frames are not transmitted during said quiet periods; identifying, at the receiver, quiet receiver periods in a signal that is received from said transmitter; encoding, by a receiver encoder, receiver comfort noise frames during said quiet receiver periods, wherein said receiver comfort noise frames are synchronized to said transmitter comfort noise frames and wherein the receiver's encoder having a state that depends on said receiver comfort noise frames; when not during quiet periods, decoding, by a receiver decoder, the received signal, wherein the receiver's decoder having a state that depends on said received signal; and updating the receiver's decoder on said receiver's encoder state, and updating the receiver's encoder on said receiver's decoder state;

In some embodiments in accordance with the disclosed subject matter, detecting, at a transmitter quiet periods in a signal to be transmitted is performed by a voice activity detector (VAD).

In some embodiments in accordance with the disclosed subject matter, updating a receiver's encoder on said receiver's decoder state is carried out continuously.

In some embodiments in accordance with the disclosed subject matter, updating a receiver's encoder on said receiver's decoder state is carried out only when a beginning of a quiet period is identified in the receiver.

In some embodiments in accordance with the disclosed subject matter, updating the receiver's decoder state on the receiver's encoder state is carried out continuously.

In some embodiments in accordance with the disclosed subject matter updating the receiver's decoder state on the receiver's encoder state is carried out only when an end of a quiet period is detected in the receiver.

In some embodiments in accordance with the disclosed subject matter, identifying, at the receiver quiet receiver periods in a signal that is received from said transmitter is carried out by receiving a message from the transmitter, indicating on a quiet period.

In some embodiments in accordance with the disclosed subject matter the receiver's encoder and the receiver's decoder are sharing a common hardware circuit, thus reducing the H/W and S/W resources and saving the need of mutual state updating.

In some embodiments in accordance with the disclosed subject matter, the receiver's encoder and the receiver's decoder are implemented by S/W.

In some embodiments in accordance with the disclosed subject matter, updating the receiver's decoder with receiver's encoder state or updating receiver's encoder with receiver's decoder state is done by providing pointer's to data-structs that contain the states of the receiver's encoder or the receiver's decoder.

In some embodiments in accordance with the disclosed subject matter, updating receiver's decoder with receiver's encoder state or updating receiver's encoder with receiver's decoder state is done by sharing data-structs that contain the states of the receiver's encoder or the receiver's decoder.

In some embodiments in accordance with the disclosed subject matter, the receiver is outputting comfort noise frames during said quiet receiver periods.

In an exemplary embodiment in accordance with the disclosed subject matter, there is provided An ADPCM communication system that maintains signal convergence of a transmitter and a receiver during discontinuous transmission, comprising: a transmitter that encodes transmitter comfort noise frames during quiet periods, wherein said encoded comfort noise frames are not transmitted; and a receiver having a decoder and a receiver's encoder, wherein during quiet periods the receiver's encoder encodes comfort noise receiver frames that are synchronized to said transmitter comfort noise.

In an exemplary embodiment in accordance with the disclosed subject matter, during periods that are not quiet periods the receiver's decoder decodes a signal that is received by the receiver, wherein the receiver's encoder having a state that depends on data that was previously encoded by the receiver's encoder, the receiver's decoder having a state that depends on data that was previously decoded by the receiver's encoder, and wherein the receiver's encoder is updated by the receivers decoder's state and the receiver's decoder is updated by the receiver encoder's state.

In an exemplary embodiment in accordance with the disclosed subject matter, there is provided An ADPCM communication system that maintains convergence during quiet periods, comprising: a transmitter having an encoder, comfort noise generator (CNG) and voice activity detection (VAD) unit, wherein during detection of voice signal by the VAD unit the voice signal is encoded by the transmitter's encoder and transmitted; when the transmitter's VAD unit detects a quiet period, comfort noise frames are generated by the transmitter's CNG, encoded in the transmitter's encoder but are not being transmitted; and a receiver for receiving an encoded ADPCM signal having a decoder, an encoder, and comfort noise generator (CNG), wherein when the receiver receives an ADPCM encoded voice signal the encoded ADPCM signal is decoded by the decoder; when the receiver identifies a quiet period, comfort noise frames are generated by the receiver's CNG, and encoded by the receiver's encoder; said comfort noise frames are synchronized with said transmitter comfort noise frames; wherein the receiver's encoder is updated on the decoder's state and wherein the decoder is updated on the receiver's encoder state.

In an exemplary embodiment in accordance with the disclosed subject matter, the receiver's encoder is updated on the decoder's state at the time when a start of a quiet period is detected in the receiver, and wherein the decoder is updated on the receiver's encoder state at the time when an end of a quiet period is detected in the receiver.

### BRIEF DESCRIPTION OF THE FIGURES

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of an ADPCM transmission scheme as commonly conducted according to the prior art, in accordance with an exemplary embodiment of the invention;

FIG. 2 is a block diagram of an ADPCM transmitter end according to the prior art;

FIG. 2A is a block diagram of an ADPCM encoder and decoder sharing a common hardware circuit in accordance with an exemplary embodiments of the disclosed subject matter.

FIG. 3 is a block diagram of an ADPCM receiver end according to the prior art;

FIG. 4 is a schematic illustration of an ADPCM transmission scheme that describes a system functionality during quiet periods according to the prior art.

FIG. 5 is a schematic illustration of an ADPCM transmission scheme that describes a system functionality during quiet periods in accordance with an exemplary embodiment of the invention.

FIG. 6 is a flow diagram of a method for maintaining convergence of an encoder and decoder of an adaptive differential pulse code modulated (ADPCM) communication system during discontinuous transmission, in accordance with some exemplary embodiments of the disclosed subject matter.

FIG. 7 is a flow chart describing the functionality of the transmitter and the receiver during signal transmission and during quite periods, in accordance with some exemplary embodiments of the disclosed subject matter.

### DETAILED DESCRIPTION OF EXEMPLARY EMBODIMENTS

The invention generally relates to a system and methods for maintaining convergence during quiet periods when there is no audio signal and most important to the moment of resuming the audio signal.

It should be noted that term “quiet period” that is used in this disclosure refers to any case where there is a discontinuity in the transmission, and its scope should not be limited to any specific type of discontinuity in the transmission. This term encompasses other terms as known in the art such as gaps in transmission, speech pauses etc.

For clarity of the description, a non-limiting example of a multi-media conferencing service system is described as an exemplary embodiment of the invention.

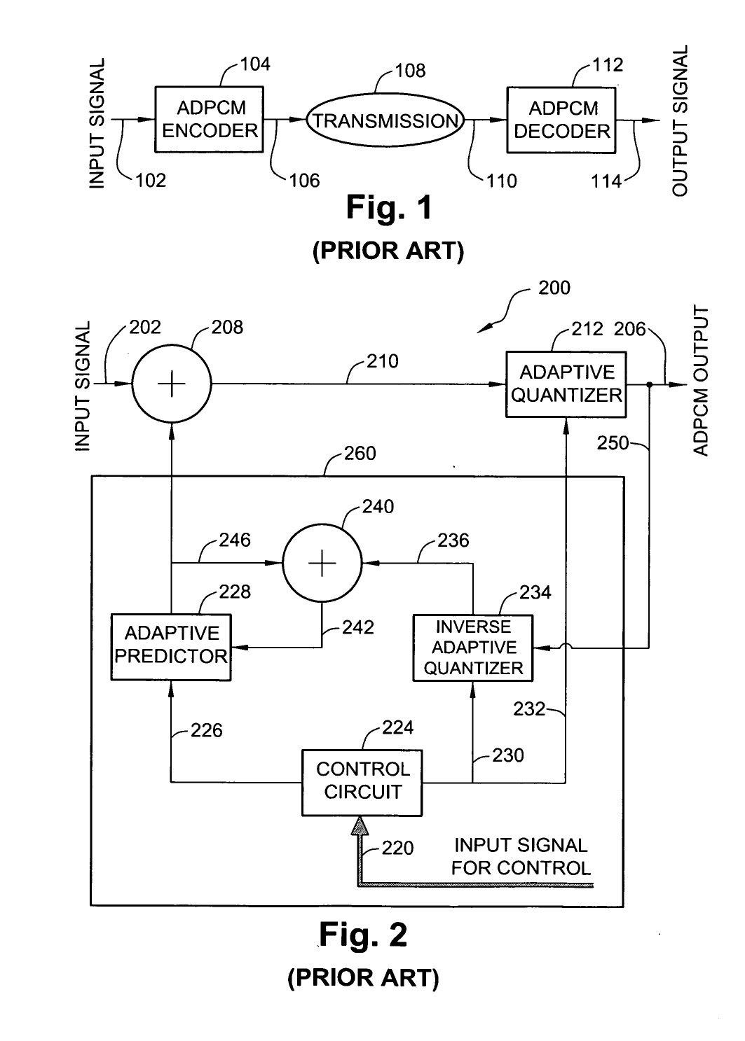

FIG. 1 is a schematic illustration of a general ADPCM transmission scheme as commonly conducted according to the prior art. The general scheme shows an input signal 102, being an input to an ADPCM encoder 104. The ADPCM encoder provides an encoded ADPCM output 106 which is transmitted 108, and being received by a receiver end as an ADPCM encoded signal 110, to be processed by an ADPCM decoder 112. The ADPCM decoder provides a decoded ADPCM output signal 114, which usually goes to a speaker circuit.

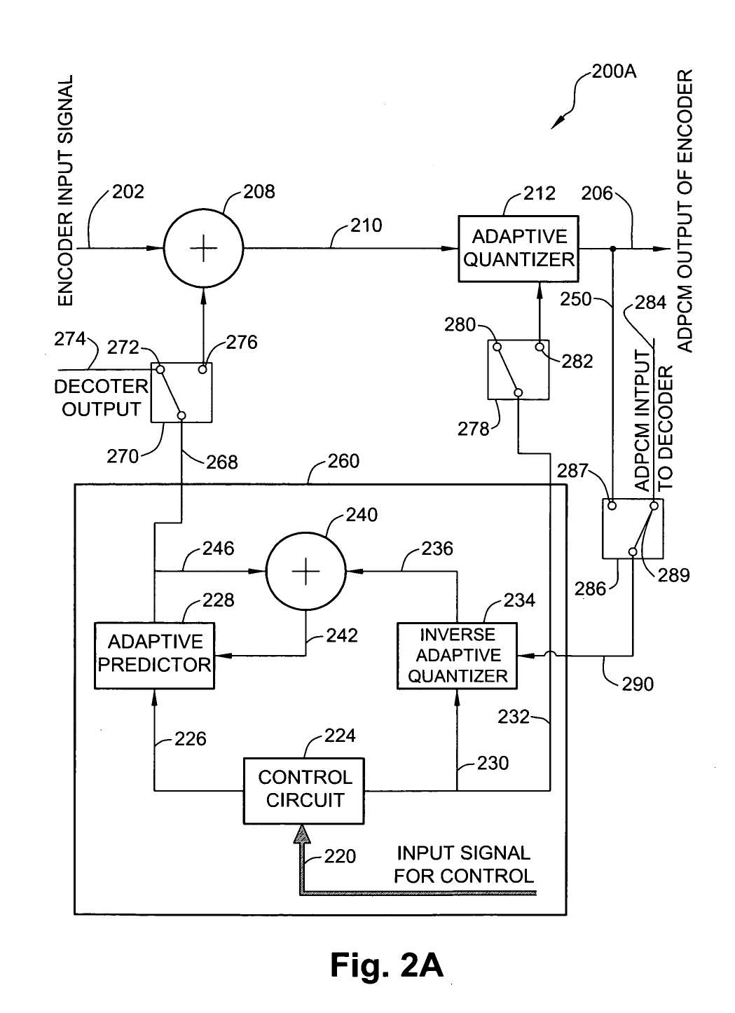

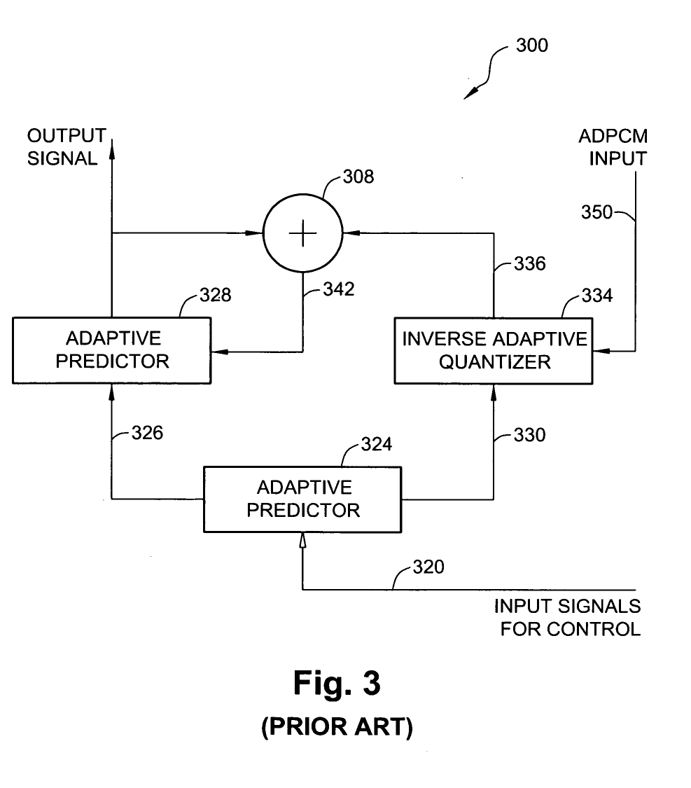

The general inner structure of the ADPCM encoder 104 and decoder 112 are shown in FIGS. 2 and 3 respectively.

FIG. 2 is a block diagram of an ADPCM encoder end according to the prior art. FIG. 2 shows a signal estimate 246 which is subtracted from an input signal 202 by add/subtract unit 208 to provide a difference signal 210. Difference signal 210 is processed by an adaptive quantizer 212 using control parameters for adaptive quantizer 232 that provides a quantized difference signal 206 that is being transmitted according to the scheme shown in FIG. 1. While audio signals have the character of relatively slow change over time, the signal that is used for transmission is just the difference signal 210 that includes enough information in order to reconstruct the input signal 202 at the receiver end.

The rest of the encoder circuit that is shown in FIG. 2 shows a feedback path circuit 260 that is used for providing the signal estimate 246. As shall be further described, the signal estimate is the product and also the output of the decoder circuit that is described in FIG. 3.

In order to provide estimate signal 246, a feedback path circuit uses the quantized ADPCM output signal 206 that undergoes an inverse adaptive quantization 234, to reconstruct a quantized differential signal 236. The quantized differential signal is added (240) to signal estimate 246 to provide a reconstructed signal 242. Reconstructed signal 242 is processed in an Adaptive Predictor 228 that is fed with control parameters 226 for adaptive prediction that are provided by control circuit 224, to provide the signal estimate 246. Inverse Adaptive Quantizer 234 and Adaptive Predictor 228 are dependant on control parameters that are provided by a control circuit 224. As shall be further described, the same control parameters are also required by the decoder circuit, and synchronization between control parameters (both for adaptive quantizer and adaptive predictor) in the encoder 200 and in the decoder ends is essential for maintaining signal convergence.

FIG. 3 is a block diagram of an ADPCM decoder end according to the prior art. As can easily be seen the decoder 300 is a sub circuit of the encoder block 200 shown in FIG. 2 wherein the elements and signals that are indicated with the numerals 308,342,328,334,326, 324,330 and 320 are corresponding to their counterparts in FIG. 2 indicated by the numerals 240,242,228,234,226, 224,230 and 220 respectively. However in the decoder, reconstructed signal 342 is the decoder's output that provides the audio signal for speaker(s) at the receiver end.

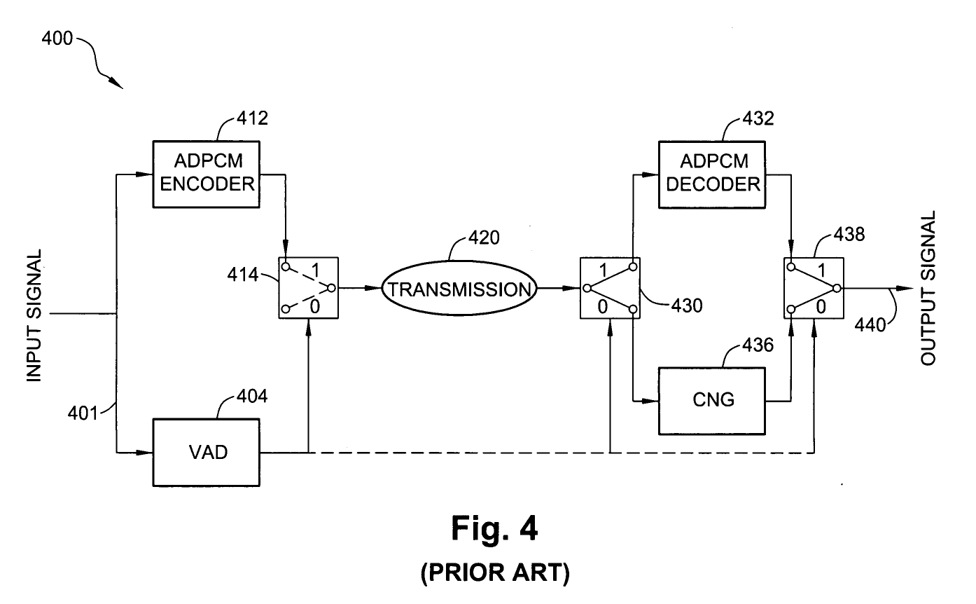

FIG. 4 is a schematic illustration of an ADPCM transmission scheme that describes a system functionality during quiet periods according to the prior art. FIG. 4 shows an ADPCM input signal 401 being an input for an ADPCM encoder 412. The input signal 401 is also being input to a Voice Activity Detection (VAD) circuit 404. When VAD circuit 404 detects a quiet period (VAD=0), a first VAD controlled switch 414 disconnects the ADPCM encoder 412 output. The reason for disconnecting the ADPCM encoder output at times when a quiet period is detected is power saving and avoiding unnecessary transmission at times when the transmitted signal has no meaning whatsoever. The received signal, after being transmitted through transmission path 420 is being input to a second VAD controlled switch 430 that disconnects the ADPCM signal path to an ADPCM decoder 432 and provides control for a Comfort Noise Generator (CNG) 436. A third VAD controlled switch 440 routes either the output of ADPCM decoder 432 output (When VAD detects a signal) or CNG 436 output to an output signal port 440. It should be noted that while the VAD 404 is shown as common to both the transmitter and receiver, practically the VAD information is communicated from the transmitter to the receiver by methods that are known in the art. Thus, it is assumed that the VAD info that is detected at the transmitter end is known in the receiver end.

The voice quality that is provided by circuit 400 suffers from a drawback since the receiver's decoder is not updated with any information during quiet periods, thus, when resuming signal transmission after a quiet period, the receiver's decoder will need some time, a transient period, for convergence, wherein within this transient period the output signal will suffer artifacts due to the discontinuity in the signal transmission.

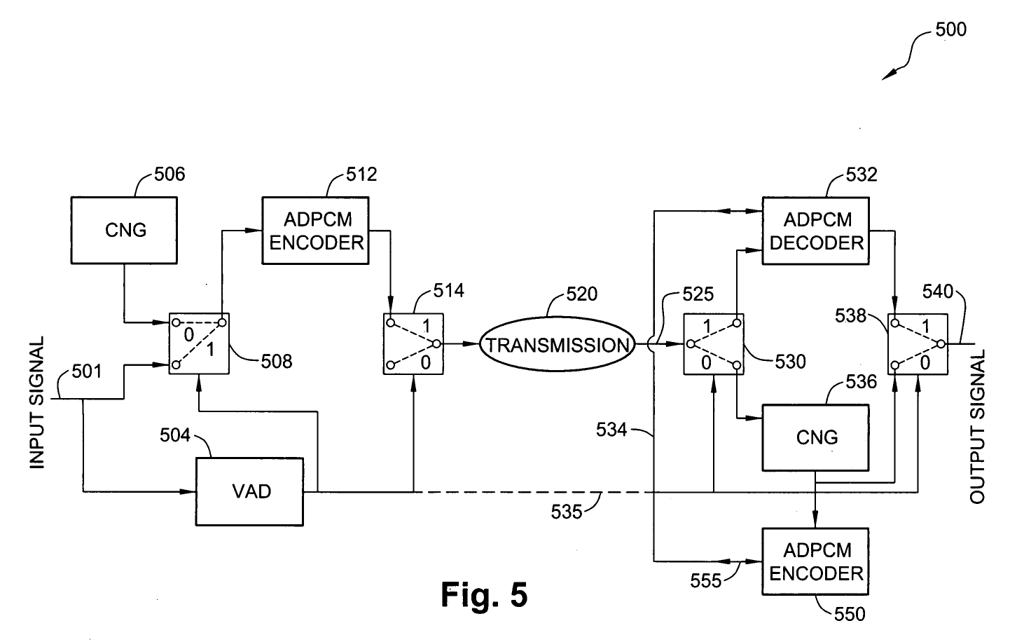

FIG. 5 is a schematic illustration of an ADPCM transmission scheme 500 that describes a system functionality during quiet periods by an exemplary non-limited embodiment of the disclosed subject matter; FIG. 5 shows an ADPCM input signal 501 being input to a VAD unit 504 and to a first VAD controlled switch 508. VAD controlled switch 508 selects which input to connect to ADPCM encoder 512 according to VAD unit 504 state. If VAD unit 504 detects a voice signal (VAD=1) than ADPCM input signal 501 is routed to ADPCM encoder unit 512. If VAD unit 504 detects a quiet period (gap in audio signal VAD=0) than the output of Comfort Noise Generator (CNG) is routed to ADPCM encoder unit 512. A second VAD controlled switch 514 disconnects transmission whenever VAD unit 504 detects a quiet period. When VAD unit 504 does not detect a quiet period the encoded ADPCM signal is transmitted through transmission path 520 and is being received at the receiver end. Received signal 525 is being input to a third VAD controlled switch 530 that routes the received signal 525 to ADPCM decoder 532 when VAD information indicates the presence of voice signal If VAD information indicates a quiet period than Comfort Noise Generator (CNG) 536 is activated and generates comfort noise packets.

It should be noted that while FIG. 5 refers to a VAD, the invention is not limited to any specific method or device for detecting quiet periods and the detection may be performed by any device or method, for example signal activity detection (SAD).

Comfort Noise Generator 536 generates comfort noise frames that are being input both to a fourth VAD controlled switch 538 to provide ADPCM output signal 540 and to ADPCM encoder 550. ADPCM encoder 550 is encoding the comfort noise frames and continuously updating ADPCM decoder 532 with control parameters. Thus, ADPCM decoder's parameters are always updated, either by the ADPCM signal when it is received from the transmitter or from ADPCM encoder when a quiet period is detected. This flow of updating parameters works also in the opposite direction, where parameters from decoder 532 are provided to the encoder 550 continuously whenever there is a voice signal present and the decoder is decoding the received signal 525. This bi-directional updating of parameters guarantees a smooth transition between the states of VAD=0 and VAD=1 by continuously keeping both decoder 532 and encoder 550 with updated parameters. It should be noted that both the decoder and encoder in the receiver are characterized by a state that is changing in time and depends inter alia on the data that was processed by the encoder/decoder. Thus, the description of updating parameters is not limited to any specific parameters but encompasses every parameter or data that is part of the encoder/decoder's state.

In another embodiment according to the disclosed subject matter the updating process is not performed continuously but only at the times of transitions. Thus, encoder 550 parameters are transferred to the decoder 532 when a quiet period is completed and decoder 532 parameters are transferred to the encoder 550 when a quiet period starts.

In yet another embodiment of the disclosed subject matter, encoder 550 and decoder 532 are implemented in a manner that updating is inherent, this can be the case when both the decoder and the encoder are implemented by S/W and they can share a common data structure that contains the relevant parameters, or in another example the process of updating parameters is merely a process of providing a pointer to a data-struct that stores the relevant parameters.

It should be noted that while it looks like a dedicated ADPCM unit has been added to the receiver's circuits, actually only a relatively small piece of hardware needs to be added to the receiver end due to the ADPCM encoder structure as was described in FIG. 2 it can be noticed that ADPCM decoder 532 can be used to provide most of ADPCM encoder 550 hardware, requiring to add only an adaptive quantizer 212 and an add/subtract unit 208. Thus, by adding just very few hardware (H/W) elements the receiver's ADPCM decoder is kept updated with control parameters also during quiet periods, resulting with smooth transitions from quiet period to active voice signal transmission. It should be further noted that practically most ADPCM communication systems are bi-directional systems that perform both transmitting and receiving, thus, these transceivers already include all the required H/W for implementing a system according to the disclosed subject matter—where the transmitter's encoder can serve as receiver's encoder and the specific functionality is determined according to the transceiver state, either transmitting or receiving.

FIG. 2A shows a block diagram of an ADPCM encoder and decoder sharing a common hardware circuit in accordance with an exemplary embodiments of the disclosed subject matter. As shown in FIG. 2A, an encoder circuit 200A can be used either as an encoder or a decoder, according to the state of switches 270, 278 and 286. In a first state, when the circuit functions as an encoder, switch 270 connects input signal 268 to contact 276, switch 278 connects input signal 232 to contact 282 and switch 286 connects ADPCM output 250 to switch 286 output 290. When a decoder functionality is required, switch 270 connects input signal 268 to contact 272 to drive decoder output 274, switch 278 connects input signal 232 to contact 280 (practically disconnects the path to adaptive quantizer 212), and switch 286 connects ADPCM input 284 to switch 286 output 290. Sharing the same H/W for encoder and decoder reduces the H/W and S/W resources that are needed and also saves the need of mutual states updating.

While FIG. 2A shows an exemplary embodiment of encoder/decoder sharing common hardware it could be readily understood by a person skilled in the art that the encoder/decoder hardware sharing could be implemented in various ways by using other methods and elements for switching between the two functionalities.

While ADPCM communication systems are often implemented by software (S/W), persons skilled in the art will readily notice that for S/W implemented ADPCM systems the implementation of an ADPCM system according to the disclosed subject matter is very simple and it does not require any additional H/W (e.g. CPU or memory).

One skilled in the art can readily understand that the proper functionality of the circuit according to the disclosed subject matter requires synchronization between the comfort noise frames that are generated in the transmitter end to the comfort noise frames that are generated in the receiver end. The synchronization is required to ensure that the transmitter's encoder and the receiver's decoder and encoder will be kept in the same states to enable convergence. Synchronization of comfort noise frames is known in the art. There are various methods to guarantee synchronization of CNG packets between the transmitter and the receiver, basically such synchronization can be achieved by sending packets that contain synchronization messages from the transmitter to the receiver. Such messages can also be sent during quiet period as they are very short relative to the typical duration of a quiet period

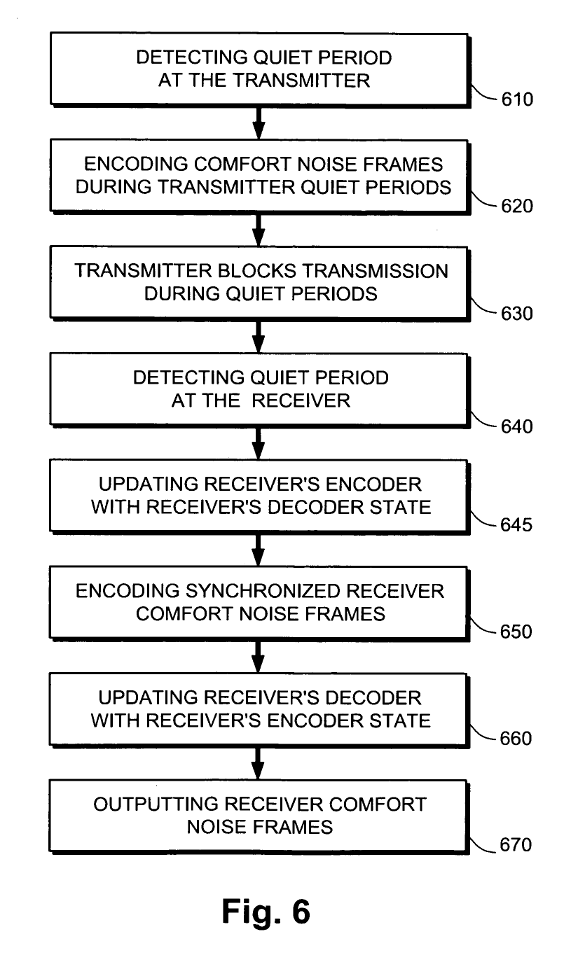

FIG. 6 is a flow diagram of a method for maintaining convergence of an encoder and decoder of an adaptive differential pulse code modulated (ADPCM) communication system during discontinuous transmission. The first step is detecting a quiet period at the transmitter end (610). In a preferred embodiment according to the disclosed subject matter this is done by a VAD unit (e.g. 404,504). When a quiet period is detected, the transmitter starts to encode comfort noise frames (620). The transmitter blocks transmission during quiet periods (630). When transmission from the transmitter is blocked, the receiver detects quiet periods (640) (e.g. by receiving a message from the transmitter). When a quiet period is detected, receiver's encoder 550 parameters are being updated with receiver's decoder 532 parameters (645). As previously described, this process can be a continuous process or an event that takes place only at the transition period and it could be implemented in various ways such as updating H/W memory units or updating a S/W pointer to a data-struct that contains the relevant parameters. Upon detection of a quiet period the receiver encodes frames of synchronized comfort noise frames (650), A smooth transition to active state of the receiver's encoder is guaranteed by continuously updating the encoder with decoder's parameter, thus, keeping the encoder continuously updated with the decoder's state. As previously explained, it is required that the comfort noise frames that are encoded by the receiver's encoder will be synchronized with the comfort noise frames that are encoded by the transmitter's encoder in order to keep both encoder's in the same state (or at least as close as possible). While encoding said synchronized comfort noise frames, receiver's decoder 532 is updated with control parameters that are derived from receiver's encoder 550 state (660). (as previously mention with reference to step 645 this process of updating parameters can be implemented in various ways). During quiet periods the receiver is outputting comfort noise frames (670). As can be readily understood, when voice signal transmission is resumed, the receiver's decoder is already updated with control parameters that match the transmitter's encoder control parameters resulting with smooth transition to receiving of transmitted ADPCM voice frames.

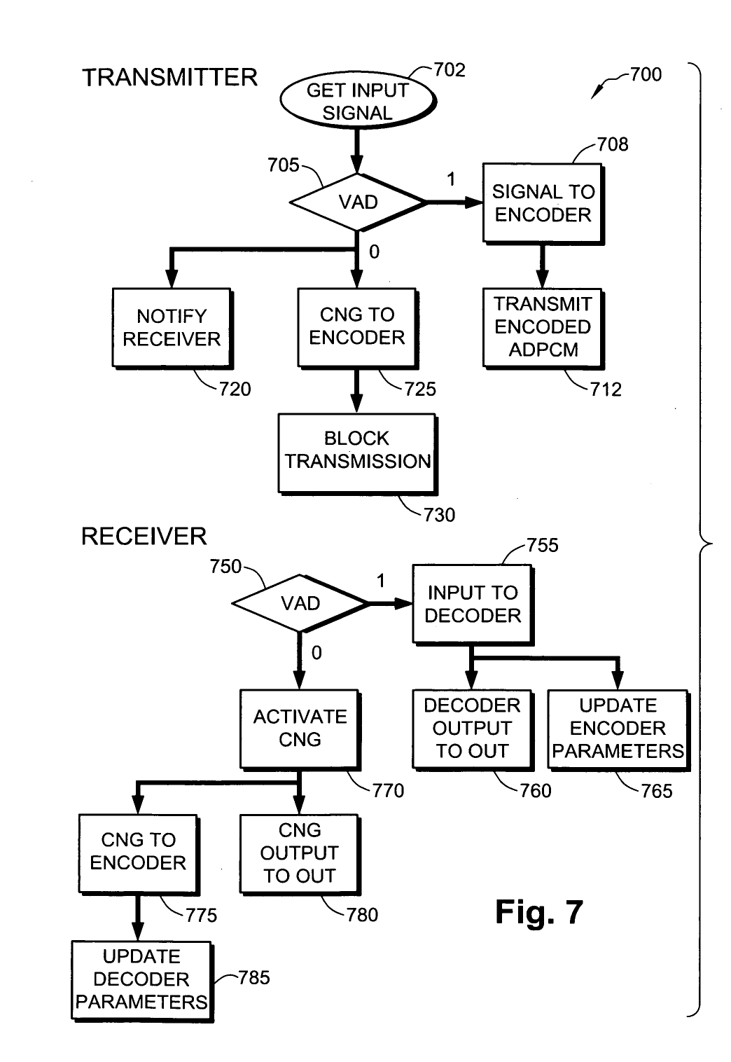

FIG. 7 is a flow chart describing the functionality of the transmitter and the receiver during signal transmission and during quite periods, in accordance with some exemplary embodiments of the disclosed subject matter. At the transmitter end an input signal (audio) is received (702) a VAD unit makes the decision whether there is an audio signal or just noise (quiet period) (705), if VAD==1 the input signal is being input to an encoder (708) whose output, encoded ADPCM signal is being transmitted to the receiver end (712). If VAD==0 comfort noise is being input to the encoder (725) and at the same time the transmitter notifies the receiver on a quiet period.

At the receiver end the flow depends on VAD notification (750): If there is a positive VAD indication the input signal is routed to the decoder (755) and decoded signal is being outputted (760) (e.g. to a speaker device) simultaneously the encoder at the receiver end is updated with parameters from the decoder (765). It should be noted that this process of updating parameters can be a continuous process which goes on as long as the decoder decodes the incoming signal, or can be a singular event that is performed only once at each time that a quiet period is detected (when VAD changes from 1 to 0). If there is a quiet period indication a CNG unit is activated (770) and the CNG output is outputted from the receiver (780), simultaneously, the CNG is being encoded by the encoder (775) and the encoder's parameters are used to update the decoder (785). It should be noted that encoding the CNG frames is performed just for producing encoder parameters that enable to update the decoder parameters. It should be noted that the flow does not refer to the synchronization between CNG frames that are generated in the transmitter and CNG frames that are generated at the receiver.

The present invention has been described using non-limiting detailed descriptions of embodiments thereof that are provided by way of example and are not intended to limit the scope of the invention. It should be understood that features described with respect to one embodiment may be used with other embodiments and that not all embodiments of the invention have all of the features shown in a particular figure or described with respect to one of the embodiments. It is noted that some of the above described embodiments may describe the best mode contemplated by the inventors and therefore include structure, acts or details of structures and acts that may not be essential to the invention and which are described as examples.

Structure and acts described herein are replaceable by equivalents, which perform the same function, even if the structure or acts are different, as known in the art. Therefore, only the elements and limitations as used in the claims limit the scope of the invention. When used in the following claims, the terms “comprise”, “include”, “have” and their conjugates mean “including but not limited to”.

1. A method of maintaining signal convergence of a transmitter and a receiver of an adaptive differential pulse code modulated (ADPCM) communication system during discontinuous transmission, said method comprising the steps of:
(a) detecting, at a transmitter quiet periods in a signal to be transmitted;
(b) encoding comfort noise frames in an encoder of the transmitter during said quiet periods in the signal to be transmitted, wherein said encoded comfort noise frames are not transmitted during said quiet periods;
(c) identifying, at the receiver, quiet receiver periods in a signal that is received from said transmitter;
(d) encoding, by a receiver encoder, receiver comfort noise frames during said quiet receiver periods, wherein said receiver comfort noise frames are synchronized to said transmitter comfort noise frames and wherein the receiver's encoder having a state that depends on said receiver comfort noise frames;
(e) when not during quiet periods, decoding, by a receiver decoder, the received signal, wherein the receiver's decoder having a state that depends on said received signal; and
(f) updating the receiver's decoder on said receiver's encoder state, and updating the receiver's encoder on said receiver's decoder state;

2. A method according to claim 1, wherein detecting, at a transmitter quiet periods in a signal to be transmitted is performed by a voice activity detector (VAD).

3. A method according to claim 1, wherein updating a receiver's encoder on said receiver's decoder state is carried out continuously.

4. A method according to claim 1, wherein updating a receiver's encoder on said receiver's decoder state is carried out only when a beginning of a quiet period is identified in the receiver.

5. A method according to claim 1, wherein updating the receiver's decoder state on the receiver's encoder state is carried out continuously.

6. A method according to claim 1, wherein updating the receiver's decoder state on the receiver's encoder state is carried out only when an end of a quiet period is detected in the receiver.

7. A method according to claim 1, wherein identifying, at the receiver quiet receiver periods in a signal that is received from said transmitter is carried out by receiving a message from the transmitter, indicating on a quiet period.

8. A method according to claim 1 wherein the receiver is outputting comfort noise frames during said quiet receiver periods.

9. A method according to claim 1, wherein the receiver's encoder and the receiver's decoder are sharing a common hardware circuit.

10. A method according to claim 1, wherein the receiver's encoder and the receiver's decoder are implemented by S/W.

11. A method according to claim 10, wherein updating the receiver's decoder with receiver's encoder state or updating receiver's encoder with receiver's decoder state is done by providing pointer's to data-structs that contain the states of the receiver's encoder or the receiver's decoder.

12. A method according to claim 10, wherein updating receiver's decoder with receiver's encoder state or updating receiver's encoder with receiver's decoder state is done by sharing data-structs that contain the states of the receiver's encoder or the receiver's decoder.

13. An ADPCM communication system that maintains signal convergence of a transmitter and a receiver during discontinuous transmission, comprising:
(a) a transmitter that encodes transmitter comfort noise frames during quiet periods, wherein said encoded comfort noise frames are not transmitted; and
(b) a receiver having a decoder and a receiver's encoder, wherein during quiet periods the receiver's encoder encodes comfort noise receiver frames that are synchronized to said transmitter comfort noise.

14. An ADPCM communication system according to claim 13, wherein during periods that are not quiet periods the receiver's decoder decodes a signal that is received by the receiver, wherein the receiver's encoder having a state that depends on data that was previously encoded by the receiver's encoder, the receiver's decoder having a state that depends on data that was previously decoded by the receiver's encoder, and wherein the receiver's encoder is updated by the receivers decoder's state and the receiver's decoder is updated by the receiver encoder's state.

15. An ADPCM communication system that maintains convergence during quiet periods, comprising:
(a) a transmitter having an encoder, comfort noise generator (CNG) and voice activity detection (VAD) unit, wherein during detection of voice signal by the VAD unit the voice signal is encoded by the transmitter's encoder and transmitted; when the transmitter's VAD unit detects a quiet period, comfort noise frames are generated by the transmitter's CNG, encoded in the transmitter's encoder but are not being transmitted; and
(b) a receiver for receiving an encoded ADPCM signal having a decoder, an encoder, and comfort noise generator (CNG), wherein when the receiver receives an ADPCM encoded voice signal the encoded ADPCM signal is decoded by the decoder; when the receiver identifies a quiet period, comfort noise frames are generated by the receiver's CNG, and encoded by the receiver's encoder; said comfort noise frames are synchronized with said transmitter comfort noise frames; wherein the receiver's encoder is updated on the decoder's state and wherein the decoder is updated on the receiver's encoder state.

16. An ADPCM communication system according to claim 15, wherein the receiver's encoder is updated on the decoder's state at the time when a start of a quiet period is detected in the receiver, and wherein the decoder is updated on the receiver's encoder state at the time when an end of a quiet period is detected in the receiver.
